(19) United States
(12) Patent Application Publication
(10) Pub. No.: US 2020/0026264 A1
(43) Pub. Date: Jan. 23, 2020

(54) FLEXIBLE JOB-SHOP SCHEDULING METHOD BASED ON LIMITED STABLE MATCHING STRATEGY

(71) Applicant: Jiangnan University, Wuxi, Jiangsu (CN)

(72) Inventors: Qibing ZHU, Wuxi, Jiangsu (CN); Yu YANG, Wuxi, Jiangsu (CN); Min HUANG, Wuxi, Jiangsu (CN); Ya GUO, Wuxi, Jiangsu (CN)

(21) Appl. No.: 16/325,571

(22) PCT Filed: Mar. 16, 2018
(86) PCT No.: PCT/CN2018/079333

§ 371 Date: Feb. 14, 2019

(30) Foreign Application Priority Data
Feb. 7, 2018 (CN) 201810124599.8

(51) Int. Cl. G05B 19/418; G06N 3/12; G06N 7/00

(52) U.S. Cl. CPC G05B 19/41865; G06N 7/005; G06N 3/126

(57) ABSTRACT

The present invention provides a flexible job-shop scheduling method based on a limited stable matching strategy, and belongs to the field of job-shop scheduling. The method adopts the following design solution: a. generating an initial chromosome population through integer coding and initializing relevant parameters; b. conducting crossover and mutation operations on parent chromosomes to obtain progeny chromosomes; c. combining the progeny chromosomes and the parent chromosomes into a set of to-be-selected chromosomes, and selecting a next generation of chromosomes from the set through limited stable matching operation; and d. stopping the algorithm if meeting cut-off conditions; otherwise turning to step b. The present invention introduces a limited stable matching strategy into the selection process of the progeny chromosomes to solve a multi-target flexible job-shop scheduling problem, so as to overcome the defects of insufficient population distribution and insufficient convergence in the existing method for solving the multi-target flexible job-shop scheduling problem when solving such problem, thereby obtaining excellent scheduling solution with good timeliness and high reliability.

### TECHNICAL FIELD

The present invention belongs to the field of job-shop scheduling, relates to a method for solving a multi-target flexible job-shop scheduling problem, and in particular to a flexible job-shop scheduling method based on a limited stable matching strategy.

### BACKGROUND

Job-shop scheduling plays an important role in the optimal allocation and scientific operation of resources, and is the key for enterprises to realize smooth and efficient operation of manufacturing systems. Flexible job-shop scheduling problem (FJSP) refers to the reasonable arrangement of processing machines and working time of all workpiece processes in a job shop where parallel machines and multi-function machines coexist, so as to achieve given multi-performance index optimization. FJSP breaks through the limit of the classical shop scheduling problem on the machines. Each process can be completed on multiple machines, which can better reflect the flexible feature of modern manufacturing systems and is also closer to the processing flow of actual production. FJSP includes machine allocation problem and process scheduling problem, has the characteristics of multiple constraint conditions and high calculation complexity and belongs to a typical NP-hard problem. The research on the solving strategy of FJSP has been one of the hot spots in the fields of production management and combinatorial optimization, and has important theoretical and practical application values. Solutions obtained by using the existing FJSP solving algorithm can be better converged to the Pareto frontier, and have better convergence performance. Good chromosomes can be selected from a Pareto solution set corresponding to the Pareto frontier, and decoded into a scheduling solution that conforms to decision requirements, but cannot provide decision makers with a wider range scheduling solutions because of the defect of the diversity of the algorithm.

### SUMMARY

The purpose of the present invention is to overcome the defects of the original method that cannot provide a wide range of optimal scheduling solutions, so as to propose a method for solving multi-target FJSP by using a limited stable matching strategy, which can improve the diversity of solutions by using the limit information, thereby providing decision makers with better and more scheduling solutions. The present invention adopts the following technical solution:

A flexible job-shop scheduling method based on a limited stable matching strategy comprises the following steps:

a. initializing related parameters: obtaining an initial chromosome population meeting constraint conditions through integer coding according to specific contents of a production order; determining a neighborhood of each subproblem; and calculating a fitness value;

b. selecting a parent chromosome from the neighborhood of each subproblem; generating progeny chromosomes through simulated binary crossover and polynomial mutation; and calculating a fitness value;

c. selecting progeny populations:

c1. combining a set of generated progeny chromosomes and a set of original parent chromosomes into a set S={s₁, s₂, . . . , s_{2N}} of to-be-selected chromosomes, and mapping the set to a target space to obtain a set X={x₁, x₂, . . . , x_{2N}} of to-be-selected solutions, a subproblem set P={p₁, . . . , pₜ, . . . , p_{N}} and a weight vector set w={ω₁, . . . , ωₜ, . . . , ω_{N}}, wherein N is the number of the chromosomes;

c2. selecting the angle of the solution relative to the subproblem as position information θ;

c3. constructing an adaptive transfer function, and using the position information θ to obtain limit information;

c4. obtaining preference values through a preference value calculation formula of the subproblem with limit information for the solutions; arranging the preference values in an ascending order to obtain a preference sequence of the subproblem for all solutions; and conducting the same operation for all the subproblems to obtain a preference matrix ψₚ;

c5. obtaining the preference values through the preference value calculation formula of the solutions for the subproblems; arranging the preference values in an ascending order to obtain a preference sequence of the solutions for all the subproblems; and conducting the same operation for all the subproblems to obtain a preference matrix ψₓ;

c6. using the information of the preference matrices ψₚ and ψₓ as input, and delaying an acceptance procedure to obtain a stable matching relationship of the subproblems and the solutions, thereby selecting progeny solutions and also selecting chromosomes corresponding to the progeny solutions; and

d. outputting a population Pareto solution set when meeting cut-off conditions; selecting a chromosome by a decision maker from the Pareto solution set according to practical needs; decoding the chromosome to form a feasible scheduling solution; otherwise, returning to step b.

Acquisition of the position information θ in the step c2: firstly, converting an m-dimensional target space F(x)=[f₁(x), . . . fₗ(x), . . . fₘ(x)]ϵR^{m} into Cₘ² two-dimensional spaces F_{c}(x)=[fᵤ(x), fᵥ(x)], wherein c is a number of the two-dimensional spaces, c=1, 2, . . . Cₘ²; u and v are numbers of space dimensionality, u, v ϵ[1, 2, . . . , m]; fᵤ(x) and fᵥ(x) respectively indicate target values of the solution x ϵX in the two-dimensional spaces; then determining a component ωᵤᵥ=(ωᵤ, ωᵥ) of the weight vector ωϵw corresponding to the subproblem p ϵP in the two-dimensional spaces; and finally, calculating an angle component θᵤᵥ(x, p) of the position information θ: θᵤᵥ(x, p)=arc tan(|fᵤ(x)−ωᵤ|/|fᵥ(x)−ωᵥ|), wherein angle θ is a sum of angle components of the subproblem p and the solution x on Cₘ² two-dimensional planes, θᵤᵥ(x, p)ϵ[0, π/2];

the limit information in the step c3 is obtained through the position information θ and the transfer function, and the transfer function is shown in formula (1):

$${T}_{L} ( θ ) = \frac{1}{1 + {e}^{- 9 ( θ / π - 1 ) / L}} \qquad ( 1 )$$

wherein L is a control parameter, and the larger the L is, the more uniform the transfer function is; in order to solve the problem of overconvergence in the early stage of iteration and ensure the balance of convergence and diversity in the later stage of iteration, with the iteration of the algorithm, L setting is gradually increased from 1 to 20.

In the step c4, calculation steps of the preference matrix ψₚ of the subproblems for the solutions comprise: calculating preference value Δp of the subproblem p for a candidate solution x through formula (2) to obtain preference values of the subproblem p for 2N candidate solutions; arranging the preference values in an ascending order to obtain a preference sequence of one subproblem for the solutions; using the preference sequence as a row of the preference matrix ψₚ; and calculating the preference sequences of all the subproblems for the solutions through the same method to obtain a preference matrix ψₚ of the subproblems with the limit information for the solutions, and thus ψₚ being N×2N matrix,

$$Δ p ( p , x , θ ) = {g}^{tch} ( x \vert ω , {z}^{*} ) \cdot {T}_{L} ( θ ) = \frac{{max}_{1 \leq l \leq m} \{ \vert {f}_{l} ( x ) - {z}_{l}^{*} \vert / {ω}_{l} \}}{1 + {e}^{- 9 ( θ / π - 1 ) / L}} \qquad ( 2 )$$

wherein ω is a weight vector of the subproblem p and z* is a reference point, wherein

$${z}_{l}^{*} = {min}_{x ∈ X} {f}_{l} ( x ) , l = 1 , 2 , … , m .$$

In the step c5, calculation steps of the preference matrix ψₓ of the solutions for the subproblems comprise:

calculating the preference value of the solution x for the subproblem p through formula (3) to obtain preference values of the solution x for N subproblems; arranging the preference values in an ascending order to obtain a preference sequence of one solution for the subproblems; and using the preference sequence as a row of the preference matrix ψₓ, and thus ψₓ being 2N×N matrix,

$$Δ x ( x , p ) = ‖ \overline{F} ( x ) - \frac{{ω}^{T} \cdot \overline{F} ( x )}{{ω}^{T} \cdot ω} ω ‖ \qquad ( 3 )$$

wherein F(x) is a target vector for standardization of the solution x and ∥·∥ is Euclidean distance.

The present invention has the beneficial effect: the limit formation is added to the calculation of the preference values of the subproblems for the solutions, so that the solutions close to the subproblems are at the front end of the preference matrix of the subproblems for the solutions, to increase the selection probability of the solutions close to the subproblems in the target space. In this way, the diversity of the selected solutions during evolution is increased, the selected solutions will not be converged in a very narrow region, and the overconvergence problem is solved. The main purpose of the above practice is to balance the diversity and the convergence of the solutions during evolution, so as to obtain Pareto solution set with better convergence and diversity at the end of the algorithm. The Pareto solution set obtained by the above method can be decoded to obtain an optimized scheduling solution that is more conformable to the actual production requirements.

### DESCRIPTION OF DRAWINGS

FIG. 1 is a flow chart of an algorithm.

FIG. 2 is a functional diagram of a limit operator.

FIG. 3 is a Pareto frontier of an actual production order solved by different solving strategies.

Reference numbers in the embodiments of the present invention are as follows by combining with the drawings:

1—distribution of solutions selected without limit information; 2—distribution of solutions selected with limit information; 3—Pareto frontier obtained by solving FJSP using the solving strategy proposed in the present invention; 4—Pareto frontier obtained by solving FJSP using a genetic algorithm solving strategy of non-dominated sorting with an elitist strategy; and 5—Pareto frontier obtained by solving FJSP using a multi-target evolution algorithm solving strategy based on a stable matching selection strategy.

### DETAILED DESCRIPTION

The present invention is further described below in combination with specific drawings and embodiments.

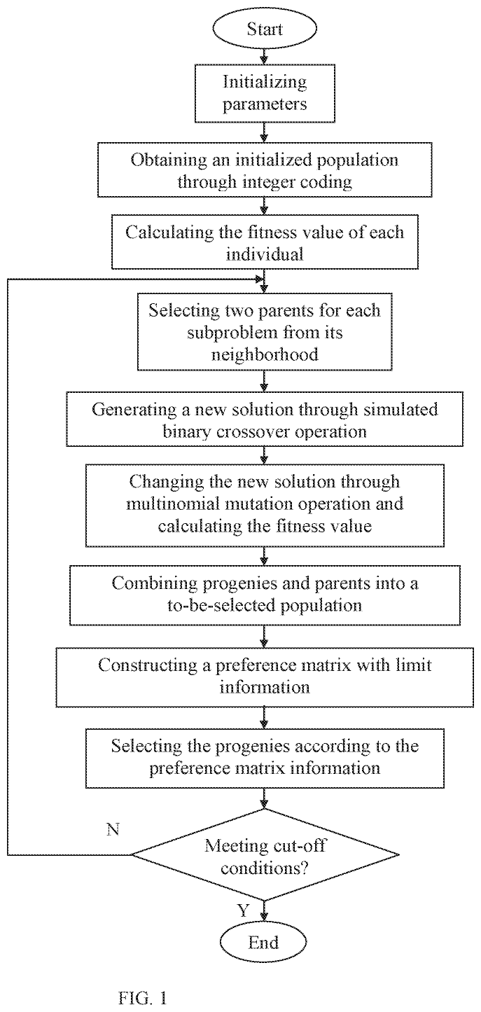

As shown in FIG. 1, to obtain a production process scheduling solution that is more conformable to the actual production, the method for obtaining a multi-target FJSP by a limited stable matching strategy in the present invention comprises the following steps:

a. initializing relevant parameters and populations

a1. initializing relevant parameters, comprising populations and target space dimensionality m=2, chromosome number N=40, crossover probability P_{c}=0.8, mutation probability Pₘ=0.6, iterations K=400, neighborhood parameter T=5 and limit operator control parameter L=1;

a2. setting a group of uniformly distributed weight vector w={ω₁, . . . , ωₜ, . . . , ω_{N}}, wherein one vector ωₜ=(ω_{t,1}, . . . , ω_{t,l}, . . . , ω_{t,m})ϵR^{m}, ω_{t,l}≥0, simultaneously obtaining a subproblem set P={p₁, . . . , pₜ, . . . , p_{N}}, calculating the Euclidean distance from each weight vector to another weight vector, for the weight vector ωₜ, t=1, 2, . . . , N, setting a set B(t)={t₁, t₂, . . . , t_{T}}, and then ω¹, ω², . . . , ω^{T} being T vectors which are closest to ωₜ;

a3. randomly producing a population S={s₁, s₂, . . . , s_{N}} of N integer coding chromosomes, calculating fitness values to obtain a solution set X={x₁, x₂, . . . , x_{N}} in the target space, setting g=1; initializing a reference point z*=(z*₁, z*₂, . . . , z*ₘ)^{T}, wherein

$${z}_{l}^{*} = {min}_{x ∈ X} {f}_{l} ( x ) , l = 1 , 2 , … , m ;$$

and by taking “3-workpiece 3-machine” as an example, obtaining a chromosome that meets the constraint conditions through integer coding, as shown in the following table:

b. generating progeny chromosomes

for the weight vector i, randomly selecting two indexes: τ, κ from B(i) random selection, and then selecting two chromosomes s_{κ} and s_{τ}; conducting simulated binary crossover operation on s_{κ} and s_{τ} as parent chromosomes in accordance with the crossover probability P_{c}; conducting multinomial mutation operation in accordance with the mutation probability Pₘ to generate a progeny chromosome s_{N+i}; calculating fitness values to obtain a solution x_{N+i}; generating N progeny chromosomes under each evolution operation in accordance with the above operation;

c. selecting an appropriate progeny population from the selected set

c1. combining a set of generated progeny chromosomes and a set of original parent chromosomes into a set S={s₁, s₂, . . . , s_{2N}} of to-be-selected chromosomes, and a set of to-be-selected solutions being X={x₁, x₂, . . . , x_{2N}};

c2. firstly, converting an m-dimensional target space F(x)=[f₁(x), . . . fₗ(x), . . . fₘ(x)]ϵR^{m} into Cₘ² two-dimensional spaces F_{c}(x)=[fᵤ(x), fᵥ(x)], wherein c is a number of the two-dimensional spaces, c=1, 2, . . . Cₘ²; u and v are numbers of space dimensionality, u, v ϵ[1, 2, . . . , m]; fᵤ(x) and fᵥ(x) respectively indicate target values of the solution x ϵX in the two-dimensional spaces; then determining a component ωᵤᵥ=(ωᵤ, ωᵥ) of the weight vector ωϵw corresponding to the subproblem p ϵP in the two-dimensional spaces; and finally, calculating an angle component θᵤᵥ(x, p) of the position information θ: θᵤᵥ(x, p)=arc tan(|fᵤ(x)−ωᵤ|/|fᵥ(x)−ωᵥ|), wherein angle θᵤᵥ(x, p) is a sum of angle components of the subproblem p and the solution x on Cₘ² two-dimensional planes, θᵤᵥ(x, p)ϵ[0, π/2]; and θ is an algebraic sum of all angle components;

c3. constructing an adaptive transfer function, and introducing the position information θ, i.e.,

$${T}_{L} ( θ ) = \frac{1}{1 + {e}^{- 9 ( θ / π - 1 ) / L}} \qquad ( 4 )$$

wherein L is a control parameter, and the larger the L is, the more uniform the transfer function is; in order to solve the problem of overconvergence in the early stage of iteration and ensure the balance of convergence and diversity in the later stage of iteration, with the iteration of the algorithm, L setting is gradually increased from 1 to 20;

c4. calculating preference values through a preference value calculation formula of the subproblem with limit information for the solutions, e.g., calculating the preference value of the subproblem pᵣ, r=1, . . . , N for the candidate solution x, x ϵS through formula (5) to obtain preference values of the subproblem pᵣ for 2N candidate solutions; arranging the preference values in an ascending order to obtain a preference sequence of one subproblem for the solutions; and using the preference sequence as a row of ψₚ, and thus ψₚ being N×2N matrix,

$$Δ p ( {p}_{r} , x , θ ) = {g}^{tch} ( x \vert {ω}_{r} , {z}^{*} ) \cdot {T}_{L} ( θ ) = \frac{{max}_{1 \leq l \leq m} \{ \vert {f}_{l} ( x ) - {z}_{l}^{*} \vert / {ω}_{r , l} \}}{1 + {e}^{- 9 ( θ / π - 1 ) / L}} \qquad ( 5 )$$

wherein ωᵣ is a weight vector of the subproblem pᵣ and z* is a reference point;

c5. calculating the preference value of the solution x ϵX for the subproblem p ϵP through formula (6), e.g., calculating the preference value of the solution xₗ for N subproblems; arranging the preference values in an ascending order to obtain a preference sequence of one solution for the subproblems; and using the preference sequence as a row of ψₓ, and thus ψₓ being 2N×N matrix,

$$Δ x ( {x}_{t} , p ) = ‖ \overline{F} ( {x}_{t} ) - \frac{{ω}^{T} \cdot \overline{F} ( x )}{{ω}^{T} \cdot ω} ω ‖ \qquad ( 6 )$$

wherein F̅(x) is a target vector for standardization of the solution x and ∥·∥ is Euclidean distance;

c6. using the information of the preference matrices ψₚ and ψₓ as input, and delaying an acceptance procedure to selection the solutions; selecting chromosomes corresponding to the selected solutions; and setting g=g+1;

d. judging whether cut-off conditions are satisfied

returning to step b if g<K, otherwise outputting Pareto solution set; and selecting a certain solution according to the will of the decision maker and decoding the solution into a feasible scheduling solution.

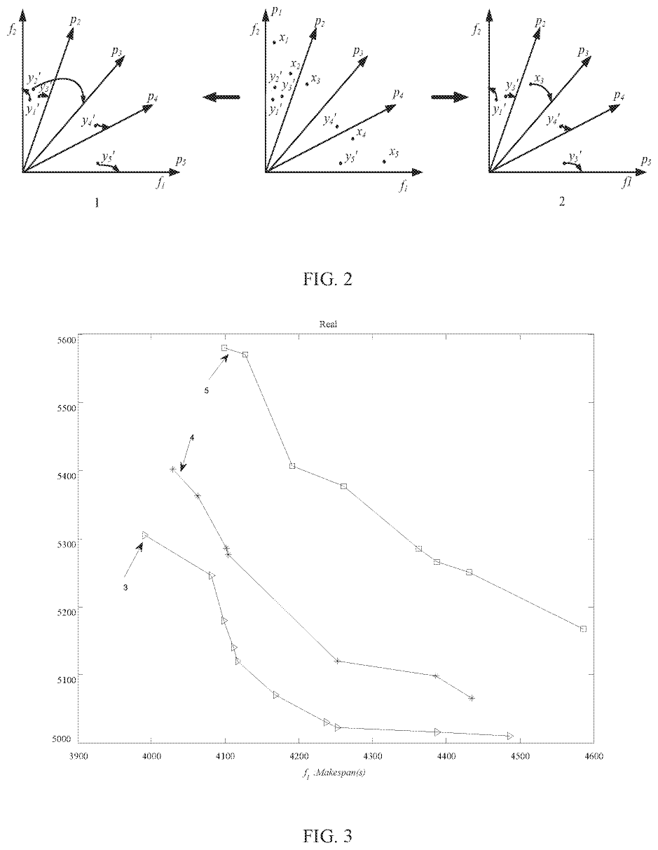

The solutions selected during evolution in the present invention have good diversity, as shown in FIG. 2. The selected solutions are uniformly distributed in the target space. FIG. 3 proves that the present invention is effective in optimal scheduling of the actual production process.

1. A flexible job-shop scheduling method based on a limited stable matching strategy, comprising the following steps:
(a) initializing related parameters: obtaining an initial chromosome population meeting constraint conditions through integer coding according to specific contents of a production order; determining a neighborhood of each subproblem; and calculating a fitness value;
(b) selecting a parent chromosome from the neighborhood of each subproblem; generating progeny chromosomes through simulated binary crossover and polynomial mutation; and calculating a fitness value;
(c) selecting progeny populations:
(c1) combining a set of generated progeny chromosomes and a set of original parent chromosomes into a set S={s₁, s₂, . . . , s_{2N}} of to-be-selected chromosomes, and mapping the set to a target space to obtain a set X={x₁, x₂, . . . , x_{2N}} of to-be-selected solutions, a subproblem set P={p₁, . . . , pₜ, . . . , p_{N}} and a weight vector set w={ω₁, . . . , ωₜ, . . . , ω_{N}}, wherein N is the number of the chromosomes;
(c2) selecting the angle of the solution relative to the subproblem as position information θ;
(c3) constructing an adaptive transfer function, and using the position information θ to obtain limit information;
(c4) obtaining preference values through a preference value calculation formula of the subproblem with limit information for the solutions; arranging the preference values in an ascending order to obtain a preference sequence of the subproblem for all solutions; and conducting the same operation for all the subproblems to obtain a preference matrix ψₚ;
(c5) obtaining the preference values through the preference value calculation formula of the solutions for the subproblems; arranging the preference values in an ascending order to obtain a preference sequence of the solutions for all the subproblems; and conducting the same operation for all the subproblems to obtain a preference matrix ψₓ;
(c6) using the information of the preference matrices ψₚ and ψₓ as input, and delaying an acceptance procedure to obtain a stable matching relationship of the subproblems and the solutions, thereby selecting progeny solutions and also selecting chromosomes corresponding to the progeny solutions; and
(d) outputting a population Pareto solution set when meeting cut-off conditions; selecting a chromosome by a decision maker from the Pareto solution set according to practical needs; decoding the chromosome to form a feasible scheduling solution; otherwise, returning to step (b).

2. The flexible job-shop scheduling method according to claim 1, wherein the acquisition process of the position information θ in the step (c2) is as follows:
firstly, converting an m-dimensional target space F(x)=[f₁(x), . . . fₗ(x), . . . fₘ(x)]ϵR^{m} into Cₘ² two-dimensional spaces F_{c}(x)=[fᵤ(x), fᵥ(x)], wherein c is a number of the two-dimensional spaces, c=1, 2, . . . Cₘ²; u and v are numbers of space dimensionality, u, v ϵ[1, 2, . . . , m]; fᵤ(x) and fᵥ(x) respectively indicate target values of the solution x ϵX in the two-dimensional spaces; then determining a component ωᵤᵥ=(ωᵤ, ωᵥ) of the weight vector ωϵw corresponding to the subproblem p ϵP; and finally, calculating an angle component θᵤᵥ(x, p) of the position information θ: θᵤᵥ(x, p)=arc tan(|fᵤ(x)−ωᵤ|/|fᵥ(x)−ωᵥ|), wherein θᵤᵥ(x, p)ϵ[0, π/2], θ is an algebraic sum of Cₘ² angle components of the solutions and the subproblems.

3. The flexible job-shop scheduling method according to claim 1, wherein the limit information in the step (c3) is obtained through the position information θ and the transfer function, and the transfer function is shown in formula (1):
$${T}_{L} ( θ ) = \frac{1}{1 + {e}^{- 9 ( θ / π - 1 ) / L}} ; \qquad ( 1 )$$
wherein L is a control parameter, and the larger the L is, the more uniform the transfer function is; in order to solve the problem of overconvergence in the early stage of iteration and ensure the balance of convergence and diversity in the later stage of iteration, with the iteration of the algorithm, L setting is gradually increased from 1 to 20.

4. The flexible job-shop scheduling method based on the limited stable matching strategy according to claim 1, wherein in the step (c4), calculation steps of the preference matrix ψₚ of the subproblems for the solutions comprise:
calculating the preference value Δp of the subproblem p for the solution x through formula (2) to obtain preference values of the subproblem p for 2N solutions; arranging the preference values in an ascending order to obtain a preference sequence of one subproblem for the solutions; using the preference sequence as a row of the preference matrix ψₚ; and calculating the preference sequences of all the subproblems for the solutions through the same method to obtain a preference matrix ψₚ of the subproblems with the limit information for the solutions, and thus ψₚ being N×2N matrix,
$$Δ p ( p , x , θ ) = {g}^{tch} ( x \vert ω , {z}^{*} ) \cdot {T}_{L} ( θ ) = \frac{{max}_{1 \leq l \leq m} \{ \vert {f}_{l} ( x ) - {z}_{l}^{*} \vert / {ω}_{l} \}}{1 + {e}^{- 9 ( θ / π - 1 ) / L}} \qquad ( 2 )$$
wherein ω is a weight vector of the subproblem p and z* is a reference point, wherein
$${z}_{l}^{*} = {min}_{x ∈ X} {f}_{l} ( x ) , l = 1 , 2 , … , m .$$

5. The flexible job-shop scheduling method according to claim 3, wherein in the step (c4), calculation steps of the preference matrix ψₚ of the subproblems for the solutions comprise:
calculating the preference value Δp of the subproblem p for the solution x through formula (2) to obtain preference values of the subproblem p for 2N solutions; arranging the preference values in an ascending order to obtain a preference sequence of one subproblem for the solutions; using the preference sequence as a row of the preference matrix ψₚ; and calculating the preference sequences of all the subproblems for the solutions through the same method to obtain a preference matrix ψₚ;
$$Δ p ( p , x , θ ) = {g}^{tch} ( x \vert ω , {z}^{*} ) \cdot {T}_{L} ( θ ) = \frac{{max}_{1 \leq l \leq m} \{ \vert {f}_{l} ( x ) - {z}_{l}^{*} \vert / {ω}_{l} \}}{1 + {e}^{- 9 ( θ / π - 1 ) / L}} ; \qquad ( 2 )$$
wherein ω is a weight vector of the subproblem p and z* is a reference point, wherein
$${z}_{l}^{*} = {min}_{x ∈ X} {f}_{l} ( x ) , l = 1 , 2 , … , m .$$

6. The flexible job-shop scheduling method according to claim 1, wherein in the step (c5), calculation steps of the preference matrix ψₓ of the solutions for the subproblems comprise:
calculating the preference value of the solution x for the subproblem p through formula (3) to obtain preference values of the solution x for N subproblems; arranging the preference values in an ascending order to obtain a preference sequence of one solution for the subproblems; and using the preference sequence as a row of the preference matrix ψₓ, and thus ψₓ being 2N×N matrix;
$$Δ x ( x , p ) = ‖ \overline{F} ( x ) - \frac{{ω}^{T} \cdot \overline{F} ( x )}{{ω}^{T} \cdot ω} ω ‖ \qquad ( 3 )$$
wherein F̅(x) is a target vector for standardization of the solution x and ∥·∥ is Euclidean distance.

7. The flexible job-shop scheduling method according to claim 3, wherein in the step (c5), calculation steps of the preference matrix ψₓ of the solutions for the subproblems comprise:
calculating the preference value of the solution x for the subproblem p through formula (3) to obtain preference values of the solution x for N subproblems; arranging the preference values in an ascending order to obtain a preference sequence of one solution for the subproblems; and using the preference sequence as a row of the preference matrix ψₓ, and thus ψₓ being 2N×N matrix;
$$Δ x ( x , p ) = ‖ \overline{F} ( x ) - \frac{{ω}^{T} \cdot \overline{F} ( x )}{{ω}^{T} \cdot ω} ω ‖ \qquad ( 3 )$$
wherein F̅(x) is a target vector for standardization of the solution x and ∥·∥ is Euclidean distance.

8. The flexible job-shop scheduling method according to claim 4, wherein in the step (c5), calculation steps of the preference matrix ψₓ of the solutions for the subproblems comprise:
calculating the preference value of the solution x for the subproblem p through formula (3) to obtain preference values of the solution x for N subproblems; arranging the preference values in an ascending order to obtain a preference sequence of one solution for the subproblems; and using the preference sequence as a row of the preference matrix ψₓ, and thus ψₓ being 2N×N matrix;
$$Δ x ( x , p ) = ‖ \overline{F} ( x ) - \frac{{ω}^{T} \cdot \overline{F} ( x )}{{ω}^{T} \cdot ω} ω ‖ \qquad ( 3 )$$
wherein F̅(x) is a target vector for standardization of the solution x and ∥·∥ is Euclidean distance.
